(19) United States
(12) Patent Application Publication
(10) Pub. No.: US 2017/0321735 A1
(43) Pub. Date: Nov. 9, 2017

(54) ANTI-SHEAR-OFF PLASTIC PIN LOCATOR

(71) Applicant: FORD GLOBAL TECHNOLOGIES, LLC, Dearborn, MI (US)

(72) Inventors: Eduardo Monjaraz Lopez, Culiacan (MX); Luis Flores Alonso, Mexico City (MX); Francisco Ronquillo Melendez, Puebla (MX); Enrique Granell Peniche, Naucalpan de Juarez (MX)

(21) Appl. No.: 15/145,316

(22) Filed: May 3, 2016

(51) Int. Cl. F16B 13/02

(52) U.S. Cl. CPC F16B 13/02

(57) ABSTRACT

A pin locator includes a body having a base and a pin projecting from the base. The base includes an undercut in a first face around the pin and a sink saver in a second face of the base. A workpiece assembly is also disclosed having a first workpiece including an integral, projecting pin and an undercut around the pin as well as a second workpiece including a locator aperture for receiving and holding the pin.

### TECHNICAL FIELD

This document relates generally to the workpiece assembly field and, more particularly, to a pin locator particularly adapted for locating a plastic workpiece with respect to a sheet metal workpiece such as commonly done in the automobile manufacturing industry.

### BACKGROUND

In order to properly assemble a plastic workpiece with a sheet metal workpiece a locating action is generally required. A wide variety of features may be utilized for this purpose but not all of them grant the best fit and finish. Pin locators are one of the most common solutions but, unfortunately, they may be sheared off when interacting with a sheet metal workpiece. Further, if the pin is made too wide or too tall it may cause manufacturability issues including, for example, overheating of a workpiece mold, undesired stiffness of the molded workpiece and/or sink marks in the workpiece.

This document relates to a new and improved pin locator and to a new and improved workpiece assembly both incorporating an anti-shear pin. That anti-shear pin locator may be molded in the core/cavity direction so that no extra slides or actions are required in the mold thereby reducing the cost of the mold. Further, the pin locator advantageously avoids visible and undesired marks in the workpiece such as sink marks. In addition, the pin locator does not adversely impact the stiffness of the workpiece.

### SUMMARY

In accordance with the purposes and benefits described herein, a pin locator is provided. That pin locator comprises a body including a base and a pin projecting from the base. The base further includes an undercut in a first face around the pin.

The pin locator may further include a sink saver, in the form of a cavity, in a second face of the base. The sink saver cavity extends through the base and into the pin. Thus, the sink saver may have a depth D₁ and the undercut may have a depth D₂ where D₁>D₂.

The pin locator may have a section line wherein the base extends concentrically around the undercut which extends concentrically around the pin which extends concentrically around the sink saver cavity. Further, the pin may include a plurality of flanges. In one possible embodiment the pin includes four flanges oriented radially around the pin at 90 degree intervals. All four of those flanges may be tapered at a distal end thereof to aid in inserting the pin in a locator aperture of another workpiece or part.

In accordance with an additional aspect, a pin locator is provided which comprises a body including a base and a pin projecting from the base. Further, a sink saver cavity extends through the base into the pin.

In such an embodiment the pin may further include a plurality of flanges. In one possible embodiment, the pin includes four flanges oriented radially around the pin at 90 degree intervals. All four of those flanges may be tapered at a distal end thereof.

In accordance with yet another aspect, a workpiece assembly is provided. That workpiece assembly comprises a first workpiece including an integral pin projecting from the first workpiece and an undercut in a first face of the first workpiece around the pin. Further, the workpiece assembly includes a second workpiece having a locator aperture wherein the pin is received and held in the locator aperture.

The pin may include a plurality of flanges. In one possible embodiment, the pin includes four flanges. Those four flanges may be oriented radially around the pin at 90 degree intervals. Further, the four flanges may all be tapered at a distal end thereof. In any embodiments, the first workpiece may be molded from a plastic material. The second workpiece may be sheet metal.

In the following description, there are shown and described several preferred embodiments of the pin locator and the workpiece assembly. As it should be realized, the pin locator and the workpiece assembly are both capable of other, different embodiments and their several details are capable of modification in various, obvious aspects all without departing from the pin locator and workpiece assembly as set forth and described in the following claims.

Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the pin locator and workpiece assembly and together with the description serve to explain certain principles thereof. In the drawing figures:

FIG. 1 is a top perspective view of the pin locator.

FIG. 2 is a bottom perspective view of the pin locator illustrated in FIG. 1.

FIG. 3 is a cross-sectional view of the pin locator illustrated in FIGS. 1 and 2.

FIG. 4 is a perspective view of a workpiece assembly including a first workpiece with an integral locator pin received in the locator aperture provided in a second workpiece.

FIG. 5 is a cross-sectional view along line 5-5 of FIG. 4 illustrating the construction of the locator integrally molded as a part of the first workpiece as well as its receipt in the locating aperture in the second workpiece.

Reference will now be made in detail to the present preferred embodiments of the locator pin and the workpiece assembly, examples of which are illustrated in the accompanying drawing figures.

### DETAILED DESCRIPTION

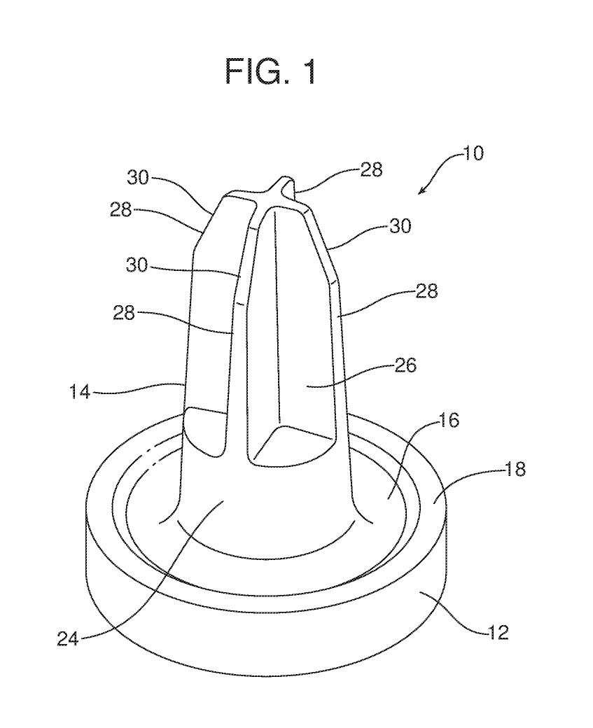

Reference is now made to FIGS. 1-3, illustrating a pin locator 10. The pin locator 10 includes a base 12 and a pin 14 projecting from the base. An undercut 16 is provided in a first face 18 of the base 12 around the pin 14. In the illustrated embodiment, the undercut 16 comprises a U-shaped channel.

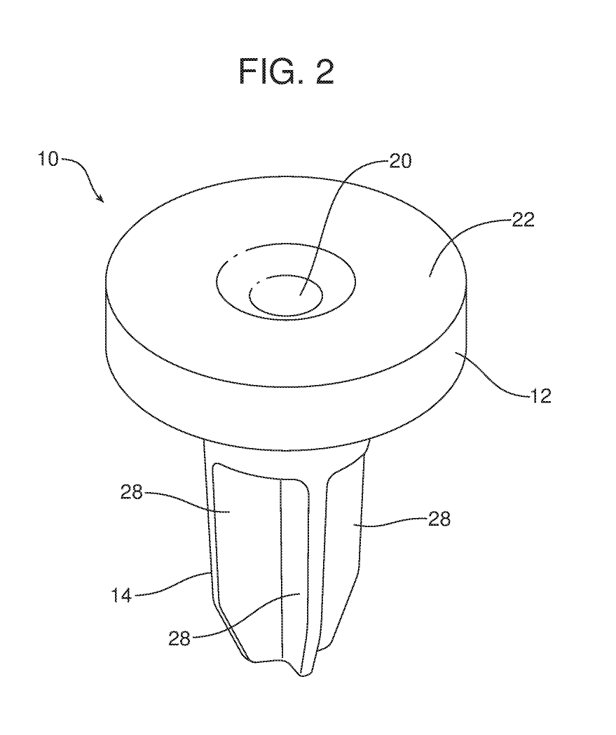

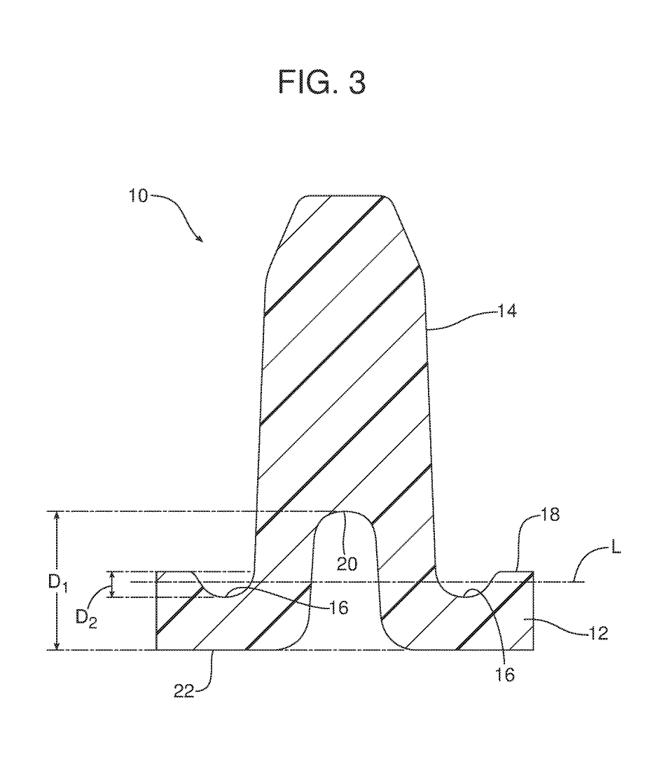

As best illustrated in FIGS. 2 and 3, a sink saver 20, in the form of a sink saver cavity, is provided in a second face 22 of the base 12. As best illustrated in FIG. 3, the sink saver cavity 20 extends through the base 12 into the pin 14. Thus, as illustrated in FIG. 3, the sink saver cavity has a depth D₁ while the undercut 16 has a depth D₂ where D₁>D₂. In addition, the pin locator has a section line L wherein the base 12 extends concentrically around the undercut 16 which extends concentrically around the pin 14 which extends concentrically around the sink saver cavity 20.

As illustrated in FIGS. 1-3, the pin 14 includes a first or proximal portion/section 24 that is substantially cylindrical in shape and a second or distal section 26 that incorporates a plurality of flanges 28. In the illustrated embodiment, the pin 14 includes four flanges 28 that are oriented radially around the pin at 90 degree intervals. Further, all four flanges 28 are tapered at the distal end 30 thereof. These tapered flanges 28 help to guide the pin 14 into a locating aperture on substantially any workpiece in a manner that will be described in greater detail below.

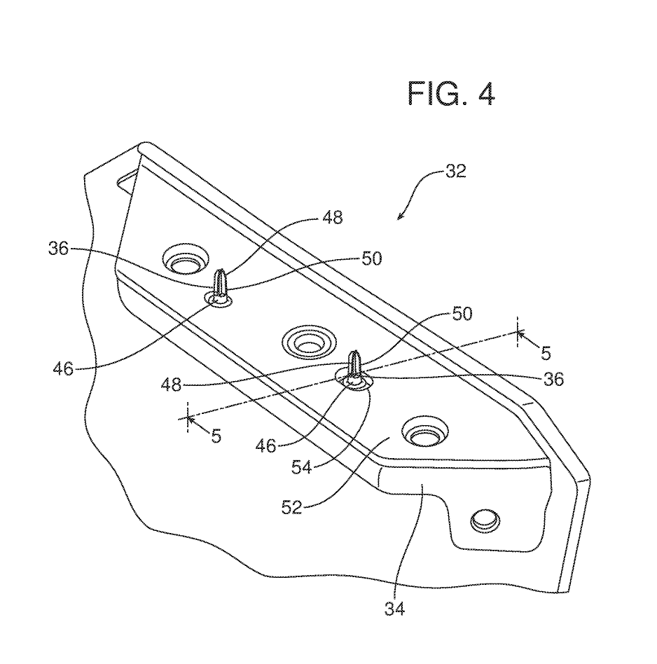

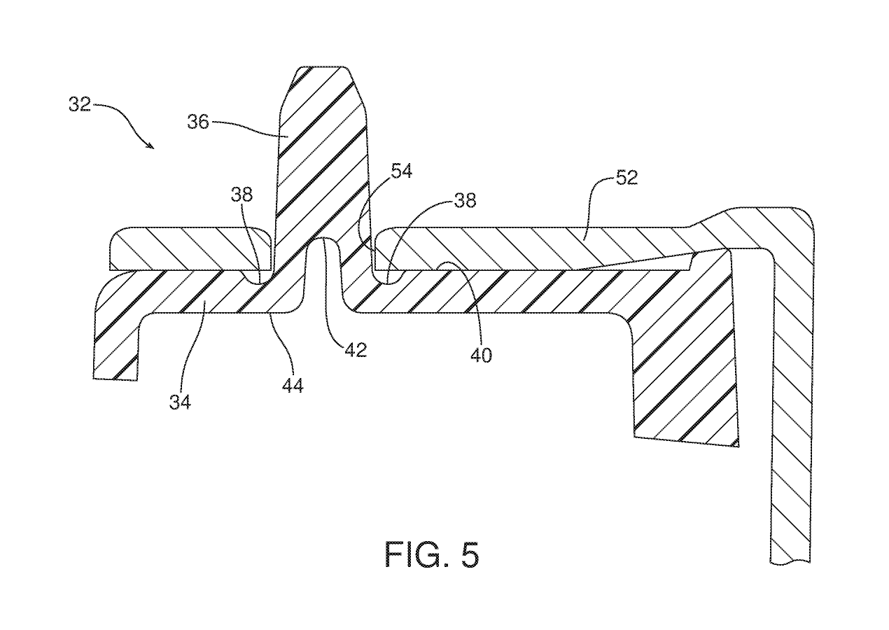

Reference is now made to FIGS. 4 and 5 illustrating a workpiece assembly generally designated by reference numeral 32. In the illustrated embodiment, the workpiece assembly 32 comprises a first workpiece 34 that may be molded from a plastic material so as to include an integral, projecting pin 36 and an undercut 38 in a first face 40 of the first workpiece. As illustrated, the undercut 38 comprises a substantially U-shaped channel that extends completely around the pin 36.

As best illustrated in FIG. 5, the first workpiece 34 also includes a sink saver cavity 42 in a second face 44 of the first workpiece. As illustrated, the sink saver cavity 42 extends into the pin 36. Thus, similar to the pin locator 10 illustrated in FIGS. 1-3, the sink saver cavity 42 has a depth D₁ and the undercut 38 has a depth D₂ where D₁>D₂.

As best illustrated in FIG. 4, the pin 36 includes a first proximal section 46 that is cylindrical in cross-section and a second, distal section 48 including four flanges 50 that are oriented radially around the pin 36 at 90 degree intervals. In the illustrated embodiment, all four flanges 50 are tapered at a distal end thereof.

As further illustrated in FIGS. 4 and 5, the workpiece assembly 32 also includes a second workpiece 52 which may be made from a sheet metal material. The second workpiece 52 includes a locator aperture 54 for each pin 36 in the first workpiece 34.

In order to attach the first workpiece 34 with the second workpiece 52, one must align the pins 36 on the first workpiece with the locator apertures 54 in the second workpiece 52. The two workpieces 34, 52 are then pressed together. As this is done, the tapered ends of the pins 36 ensure the proper location between the workpieces 34, 52. When the first workpiece 34 and second workpiece 52 are properly seated together, the pins 36 project fully through the locator apertures 54 as illustrated in FIGS. 4 and 5.

In a summary, the pin locator 10 and the workpiece assembly 32 described herein provide a number of benefits and advantages. The undercut 16 of the pin locator 10 and the undercut 38 of the workpiece assembly 32 function to improve the assembly between sheet metal and plastic workpieces (such as illustrated at 52, 34). Further, the undercut 16, 38 maximizes airflow ensuring an easier assembly.

The tapered flanges 28, 50 of the respective pin locator 10 and workpiece assembly 32 help to simplify the location of workpieces 34, 52 for good assembly. The sink saver cavity 20, 42 addresses manufacturing and overheating issues by providing a constant thickness to the pin locator 10 and pin 36 of the workpiece assembly 32.

The foregoing has been presented for purposes of illustration and description. It is not intended to be exhaustive or to limit the embodiments to the precise form disclosed. Obvious modifications and variations are possible in light of the above teachings. For example, the illustrated embodiments include four flanges 28, 50 that are radially arrayed around the respective pins 14, 36 at 90 degree intervals so as to function as four-way locators. It should be appreciated that the pins 14, 36 may include a different number of flanges or a different angular orientation of the flanges that are present. All such modifications and variations are within the scope of the appended claims when interpreted in accordance with the breadth to which they are fairly, legally and equitably entitled.

What is claimed:

1. A pin locator, comprising:
a body including a base and a pin projecting from said base wherein said base includes an undercut in a first face around said pin.

2. The pin locator of claim 1, further including a sink saver in a second face of said base.

3. The pin locator of claim 2, wherein said sink saver comprises a cavity extending through said base and into said pin.

4. The pin locator of claim 3, wherein said sink saver has a depth D₁ and said undercut has a depth D₂ where D₁>D₂.

5. The pin locator of claim 4, wherein said pin locator has a section line wherein said base extends concentrically around said undercut which extends concentrically around said pin which extends concentrically around said sink saver.

6. The pin locator of claim 5, wherein said pin includes a plurality of flanges.

7. The pin locator of claim 6, wherein said pin includes four flanges oriented radially around said pin at 90 degree intervals.

8. The pin locator of claim 7, wherein said four flanges are all tapered at a distal end thereof.

9. A pin locator, comprising:
a body including a base and a pin projecting from said base wherein a sink saver cavity extends through said base into said pin.

10. The pin locator of claim 9, wherein said pin includes a plurality of flanges.

11. The pin locator of claim 10, wherein said pin includes four flanges oriented radially around said pin at 90 degree intervals.

12. The pin locator of claim 11, wherein said four flanges are all tapered at a distal end thereof.

13. A workpiece assembly, comprising:
a first workpiece including an integral, projecting pin and an undercut on a first face of said first workpiece around said pin; and
a second workpiece including a locator aperture wherein said pin is received and held in said locator aperture.

14. The workpiece assembly of claim 13, further including a sink saver cavity in a second face of said first workpiece wherein said sink saver cavity extends into said pin.

15. The workpiece assembly of claim 14, wherein said sink saver cavity has a depth D₁ and said undercut has a depth D₂ where D₁>D₂.

16. The workpiece assembly of claim 15, wherein said pin includes a plurality of flanges.

17. The workpiece assembly of claim 16, wherein said pin includes four flanges.

18. The workpiece assembly of claim 17, wherein said four flanges are oriented radially around said pin at 90 degree intervals.

19. The workpiece assembly of claim 18, wherein said four flanges are all tapered at a distal end thereof.

20. The workpiece assembly of claim 19, wherein said first workpiece is molded from a plastic material and said second workpiece is made from sheet metal.
